(19) United States
(12) Patent Application Publication
(10) Pub. No.: US 2002/0174137 A1
(43) Pub. Date: Nov. 21, 2002

(54) Repairing alterations to computer files

(76) Inventors: Daniel Joseph Wolff, Aylesbury (GB); Lee Codel Lawson Tarbotton, Leicester (GB); Paul Nicholas Gartside, Woughton-on-the-Green (GB)

Correspondence Address: NIXON & VANDERHYE P.C., 8th Floor, 1100 North Glebe Road, Arlington, VA, 22201-4714, US

(21) Appl. No.: 09/854,457

(22) Filed: May 15, 2001

(51) Int. Cl. G06F 12/00

(52) U.S. Cl. 707/200

(57) ABSTRACT

Archive copies of active computer files are generated and stored when a computer file is created or copied onto a computer system. These archive copies are compared with the current active copies upon subsequent access to detect malicious alterations in the active copies. If such alterations are detected, then a repair of the active copy may be made by replacing it with the archived copy. This replacement may be subject to user confirmation or user defined rules. The technique may be selectively applied to certain file types, such as executable files or dynamic link libraries, that are known to infrequently change during normal use.

### BACKGROUND OF THE INVENTION

1. Field of the Invention

This invention relates to the field of data processing systems. More particularly, this invention relates to the repair of alterations, such as malicious alterations, made to stored computer files.

2. Description of the Prior Art

It is known that computer viruses and other programs can make malicious alterations to stored computer files. These can be highly damaging to the computer systems concerned. Anti-virus computer programs seek to detect the presence of computer viruses that may form part of these malicious alterations. When such computer viruses are detected, then anti-virus computer programs often provide the option to attempt to repair/disinfect/clean the computer file concerned. This is an attempt to remove the computer virus from the file and return the file to its original state. The original file may contain highly valuable data or other information and accordingly the return of this file to its original state is highly desirable for to a user compared to the simple expedient of deleting that file.

Certain types of malicious alteration and computer virus can produce changes in computer files that are extremely difficult, if not impossible, to reverse. This can be extremely inconvenient for a user. It may also be desired to repair files that have been accidentally altered

U.S. Pat. No. 5,619,095, U.S. Pat. No. 5,502,815 and U.S. Pat. No. 5,473,815 describe systems that seek to detect alterations in computer files by generating data characteristics of the computer file when first created and then comparing this with similar data generated upon an access attempt to that file to see if that file has been altered.

SUMMARY OF THE INVENTION

Viewed from one aspect the present invention provides a computer program product comprising a computer program operable to control a computer to reverse an alteration to a stored computer file, said computer program comprising:

file comparing logic operable to compare said stored computer file with an archive copy of said computer file stored when said stored computer file was created; and

alteration reversal logic operable if said file comparing logic detects that said stored computer file and said archive computer file do not match to replace said stored computer file with said archive copy of said computer file.

The invention recognises that a system that compares an active version of a computer file within an archived version of a computer file to detect a match, which may be part of countermeasures against malicious alterations such as virus infection, then the archive computer file may also be used to replace the active version of that computer file if a match does not occur. This enables essentially perfect repair of computer files that have been infected or otherwise maliciously altered to be achieved.

It will be appreciated that the replacement of the active copy with the archived copy could be subject to user confirmation by prompt or other user defined rules.

The archived copies could be stored in unencrypted form, but in preferred embodiments security is increased when the archived copies are stored in an encrypted form or on a PGP disk or similar encrypted media or volume.

The archive copies could be stored on a different physical storage device to the active copies, could be stored on a network share (both the original and the archive copies could be stored on the same or different network shares) or alternatively could be stored in a different part of the same physical storage device as the active copies.

The archiving and comparison techniques of the invention may be selectively applied to a subset of types of computer files, such as executable files and dynamic link libraries, that are known to infrequently be changed by normal users. This list of file types for which the technique is applied may be user specified.

The creation of the archive files from which repair may be made can be automated for all files, a subset of file types or for files selected upon user defined rules, such as user defined file types or file authors.

Complementary aspects of the invention also provide a method for operating a computer in accordance with the above techniques and a computer operating the above techniques.

The above, and other objects, features and advantages of this invention will be apparent from the following detailed description of illustrative embodiments which is to be read in connection with the accompanying drawings.

### BRIEF DESCRIPTION OF THE DRAWINGS

FIG. 1 schematically illustrates a portion of a computer system showing the relationship of the anti-virus systems to normal file access operations;

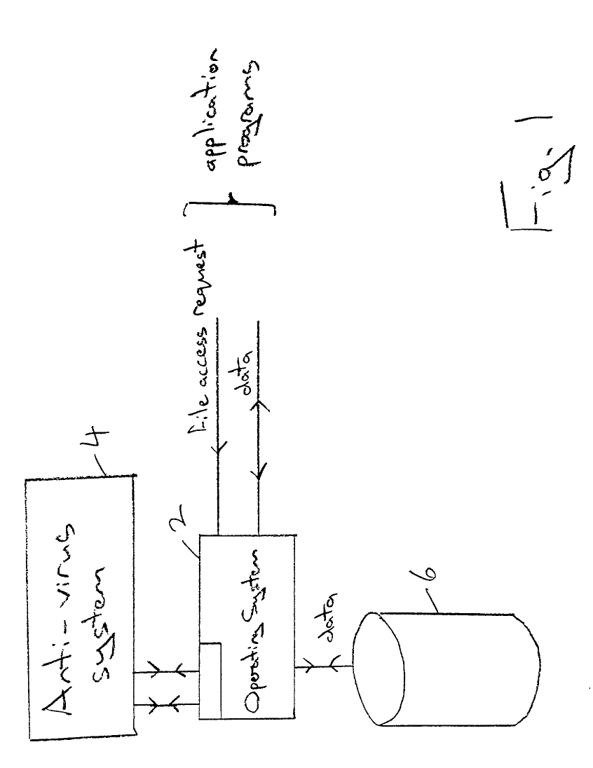

FIGS. 2 and 3 schematically illustrate possible storage locations for archive copies of computer files;

FIG. 4 is a flow diagram illustrating processing in accordance with a first embodiment;

FIG. 5 is a flow diagram illustrating processing in accordance with a second embodiment; and

FIG. 6 is a diagram schematically illustrating a general purpose computer of the type that may be used to implement the present techniques.

### DESCRIPTION OF THE PREFERRED EMBODIMENTS

FIG. I schematically illustrates the relationship between an operating system 2, an anti-virus system 4 and a data storage device 6. In normal operation file access requests from application programs are passed to the operating system 2, which then controls the servicing of those file access requests by the data storage device 6. When an on-access anti-virus system 4 is present, this then serves to intercept the normal file access requests and pass their details together with the file or parts of the file concerned to the anti-virus system 4. The anti-virus system 4 can then conduct anti-virus countermeasures, such as scanning for viruses, worms, Trojans, malware and the like. If the anti-virus system 4 detects that the file being accessed is clean, then this is indicated back to the operating system 2 and the operating system 2 then services the file access request for the application program in the normal way. Conversely, if the anti-virus system 4 detects a computer virus or other malicious content (such as a Trojan or a worm), then countermeasures are triggered, such as quarantining, cleaning or deletion.

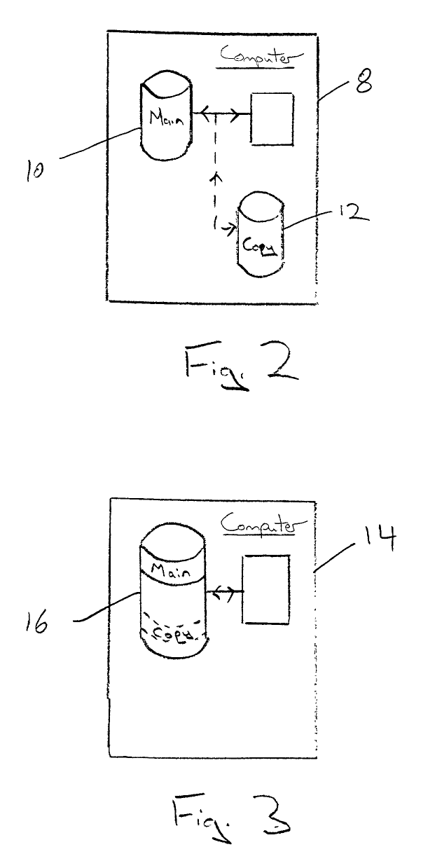

FIG. 2 schematically illustrates a computer 8 containing a first data storage device 10 and a second data storage device 12. High capacity, high speed data storage devices are becoming less expensive and accordingly the provision of a comparatively is large storage capacity within a computer 8 is quite practical. In operation, the active copies of computer files are stored upon the first data storage device 10. Archive copies of all executable and DLL files are stored to the second data storage device 12 as they created for the first time upon the first data storage device 10. These archive copies may then be compared with the main active copies upon access to those active copies at a later time to detect if there has been any alteration in those active copies. If there has been an alteration, then further countermeasures may be triggered, such as thorough anti-virus scanning.

FIG. 2 illustrates the second data storage device 12 as being incorporated within the same computer 8. This may be convenient for high speed access. However, it will be appreciated that the second data storage device 12 could be physically located within a different computer, such as on a different computer on the same computer network, providing the computer 8 does have access to that second data storage device 12 to retrieve the archived filed copies when needed or alternatively to continue operations in another way if the second data storage device 12 is unavailable.

FIG. 3 illustrates another embodiment. In this embodiment the computer 14 includes a single data storage device 14. In this case the active copies of the computer files and the archived copies of the computer files are stored on the same data storage device, but in different portions of that device, such as in different logical volumes defined on the device.

The archived copies of the computer files could be stored in an unencrypted plain form directly corresponding to the active copies of the files. However, in order to improve security, the archive copies may be encrypted for storage and require decryption to their original state prior to comparison with the active copies. The archive copies could alternatively be stored upon a PGP or other secure data storage drive or device. Known encryption and PGP techniques may be employed.

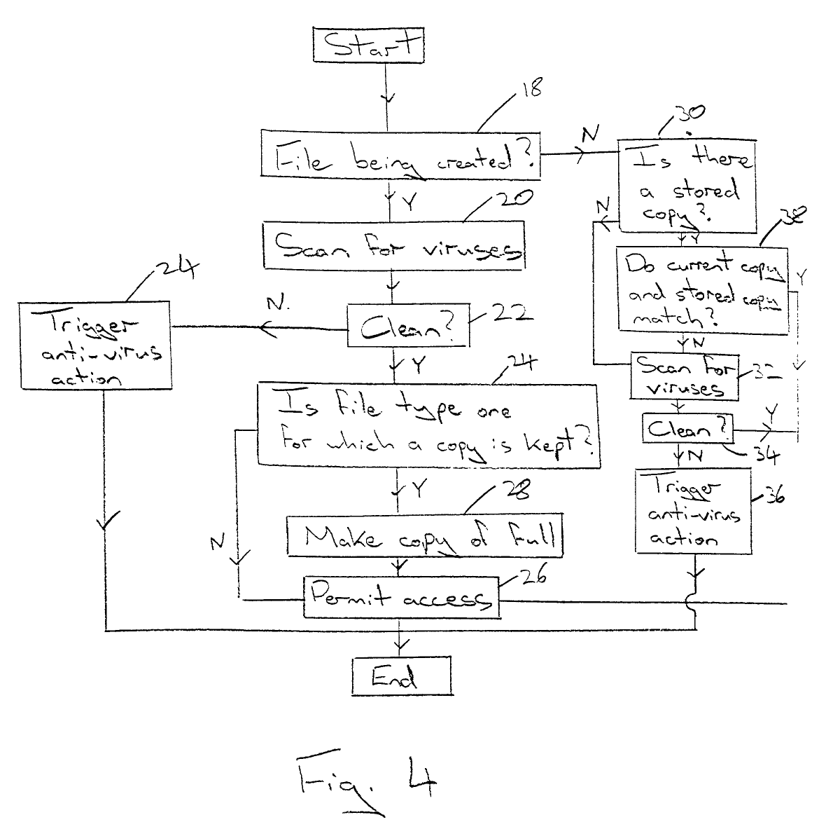

FIG. 4 illustrates a first embodiment. At step 18, when a file access request has been made, a check is performed to determine if a file is being created for the first time. If a file is being created for the first time, then that file is scanned for viruses at step 20. Step 22 determines whether or not the results of the virus scan indicated that the file being created was free of computer viruses (or other malicious content or unwanted content). If the file being created did contain any computer viruses, then processing proceeds to step 24 at which anti-virus (or other) countermeasures, such as user or administrator alerts, quarantining, deletion, cleaning etc. are triggered. If the file being created is free of computer viruses, then step 24 determines whether or not the file type of the file being created is one for which archive copies are kept. In a preferred embodiment, archive copies are kept for executable and DLL file types which are unlikely to be altered by a user during normal operation. If archive copies are not being kept, then processing proceeds to step 26 at which the access requested, in this case file creation, is permitted. If archive copies are being made for this file type, then these are created at step 28 before processing proceeds to step 26.

If the test at step 18 indicated that the access request was not one for file creation, then processing proceeds to step 30 at which a check is made to see if there is a stored archive copy of the file to which the access request is being made. If there is no stored copy, then processing proceeds to step 32, at which standard scanning for computer viruses in accordance with the normal library of virus definition data takes place. If this virus scanning indicates that the file is free from viruses at step 34, then processing proceeds to step 26 to permit the access. If the scanning indicates the presence of a virus, then anti-virus measures at step 36 are triggered.

If the test at step 30 indicates that an archived copy of the file to which the access request is being made is stored, then step 38 performs a byte-by-byte or other form of comparison of full copies of the currently active computer file and the archived computer file to check that they fully match. If the two copies do fully match, then no alterations have been made to that computer file since it was created and accordingly since the computer file was scanned for viruses when it was created, then the computer file can be treated as clean. If the comparison at step 38 does not reveal a match, then processing proceeds to step 32 where a normal scan for viruses is triggered.

It will be appreciated that periodically full on-demand virus scans of all the computer files stored, irrespective of whether there are any archive copies may be beneficial in order to provide protection against computer viruses that may have been infecting those files at the time when they were first created on the system, but were not yet known to the anti-virus systems, and accordingly were first categorised as clean and archived even though they were in fact infected. Nevertheless, for normal day-to-day operation the test conducted at steps 38 to compare the active copy of the file with the archive copy of the file and treat the file as clean if these match, provides a significant reduction in the amount of processing required and accordingly is advantageous.

It will be appreciated that step 28 could apply user defined rules to determine whether or not an archive copy is made. For example, a user could be prompted to confirm that they wish to make an archive copy. Archive copies could always be made. Archive copies could be made when the origin of the files matched a predetermined list of file types or other combinations of factors.

Step 38 in FIG. 4 is illustrated as passing a non-matching current copy through to step 32 for scanning for viruses. As an alternative, files which do not match could simply be blocked from use, or processing passed to the anti-virus actions at step 36 without requiring the scanning of step 32.

The processing illustrated in FIG. 4 is performed when a file is accessed. It may be that when embodied within an on-access scanner, this processing is carried out upon the first access to that file since activation of the scanner. Such scanners typically keep a record of previously accessed and passed-as-clean files such that they avoid re-scanning them or checking them in other ways upon subsequent accesses when they know that they have not in the intervening period been modified. This type of mechanism to reduce the processing load may be combined with the techniques described herein.

The match comparison conducted at step 38 could take a variety of forms. A byte-by-byte comparison or binary comparison could be performed in some embodiments. Alternatively, each full copy of the file could be subject to processing, such as generation of an MD5 checksum or similar, and then these results compared to verify a match between the files concerned.

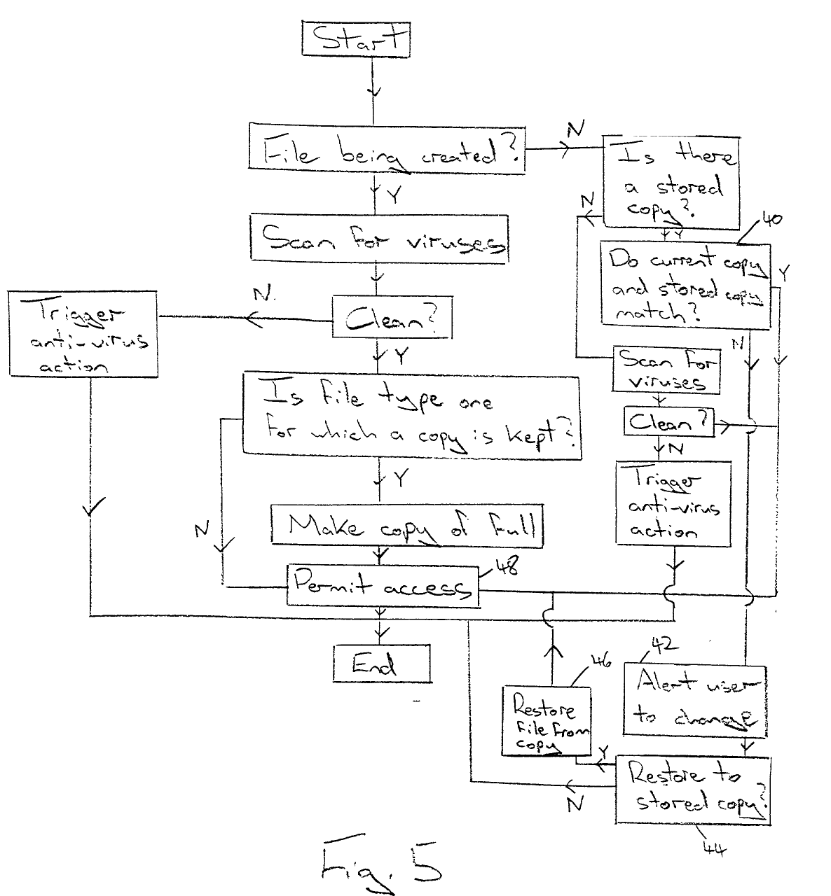

FIG. 5 illustrates processing in accordance with a second embodiment. The generation of archive copies in the first place proceeds in the same manner as for FIG. 4. The difference between the processing of FIG. 5 and that of FIG. 4 starts at the comparison step between the archive copy and the currently active copy that is performed at step 40. In this embodiment if the two copies do not match, then processing proceeds to step 42 at which the user is notified of the occurrence of the non-match. The user may define a set of rules for how processing proceeds further from this point. One possibility would be for the user to waive their right to notification and automatically restore the altered file from the archived copy at step 44. Another option may be to prompt the user for confirmation of the restore operation or to selectively restore based upon the origin of the file, the file types or some other rule.

If processing proceeds to step 44 and the user confirms the restore operation, then the currently active non-matching copy is replaced by the archived copy at step 46 and then processing proceeds to permit access at step 48. This provides file repair.

This repair technique synergistically combines with the pure alteration detection technique of FIG. 4.

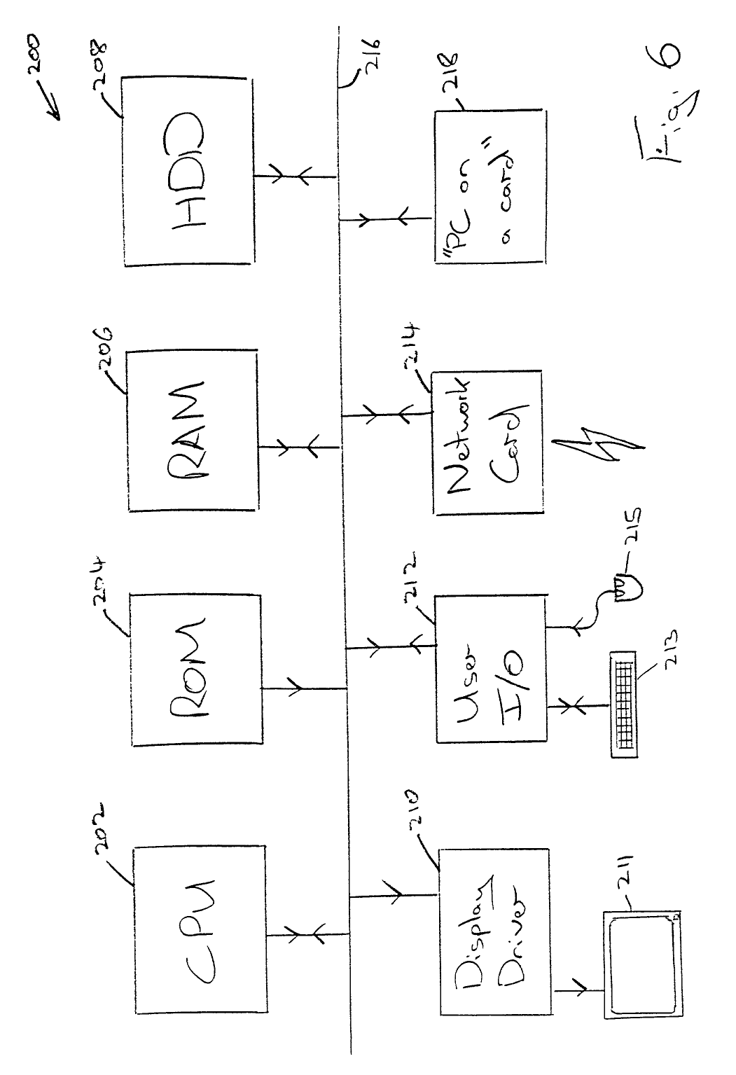

FIG. 6 illustrates a general purpose computer 200 of the type that may be used to perform the above described techniques. The general purpose computer 200 includes a central processing unit 202, a read only memory 204, a random access memory 206, a hard disk drive 208, a display driver 210 with attached display 211, a user input/output circuit 212 with attached keyboard 213 and mouse 215, a network card 214 connected to a network connection and a PC computer on a card 218 all connected to a common system bus 216. In operation, the central processing unit 202 executes a computer program that may be stored within the read only memory 204, the random access memory 206, the hard disk drive 208 or downloaded over the network card 214. Results of this processing may be displayed on the display 211 via the display driver 210. User inputs for triggering and controlling the processing are received via the user input/output circuit 212 from the keyboard 213 and mouse 215. The central processing unit 202 may use the random access 206 as its working memory. A computer program may be loaded into the computer 200 via a recording medium such as a floppy disk drive or compact disk. Alternatively, the computer program may be loaded in via the network card 214 from a remote storage drive. The PC on a card 218 may comprise its own essentially independent computer with its own working memory, CPU and other control circuitry that can co-operate with the other elements in FIG. 4 via the system bus 216. The system bus 216 is a comparatively high bandwidth connection allowing rapid and efficient commnunication.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

We claim:

1. A computer program product comprising a computer program operable to control a computer to reverse an alteration to a stored computer file, said computer program comprising:
file comparing logic operable to compare said stored computer file with an archive copy of said computer file stored when said stored computer file was created; and
alteration reversal logic operable if said file comparing logic detects that said stored computer file and said archive computer file do not match to replace said stored computer file with said archive copy of said computer file.

2. A computer program product as claimed in claim 1, wherein said archive copy of said computer file is stored in one of:
an unencrypted form;
an encrypted form;
an encrypted media;
an encrypted volume; and
a PGP disk.

3. A computer program product as claimed in claim 1, wherein said archive copy of said computer file is stored in one of:
a different physical storage device to said stored computer file; and
a different part of a common physical storage device shared with stored computer file.

4. A computer program product as claimed in claim 1, wherein a subset of file types stored by said computer are subject comparison by said file comparing logic and to creation of an archive copy for use with said file comparing logic.

5. A computer program product as claimed in claim 4, wherein said subset of file types include one or more of:
executable file types; and
dynamic link library file types.

6. A computer program product as claimed in claim 1, comprising archive file copy logic operable upon creation of said stored computer file to also created said archive copy of said computer file.

7. A computer program product as claimed in claim 6, wherein said archive file copy logic operates to create said archive copy of said computer file for a subset of file types stored by said computer.

8. A computer program product as claimed in claim 7, wherein said subset of file types include one or more of:
executable file types; and
dynamic link library file types.

9. A computer program product as claimed in claim 1, wherein said alteration is a malicious alteration.

10. A method of detecting a malicious alteration to a stored computer file, said method comprising the steps of:
comparing said stored computer file with an archive copy of said computer filestored when said stored computer file was created; and
if said file comparing step detects that said stored computer file and said archive computer file do not match, replacing said stored computer file with said archive copy of said computer file.

11. A method as claimed in claim 10, wherein said archive copy of said computer file is stored in one of:
an unencrypted form;
an encrypted form;
an encrypted media;
an encrypted volume; and
a PGP disk.

12. A method as claimed in claim 10, wherein said archive copy of said computer file is stored in one of:
a different physical storage device to said stored computer file; and
a different part of a common physical storage device shared with stored computer file.

13. A method as claimed in claim 10, wherein a subset of file types stored by said computer are subject comparison by said file comparing logic and to creation of an archive copy for use in said comparing step.

14. A method as claimed in claim 13, wherein said subset of file types include one or more of:
executable file types; and
dynamic link library file types.

15. A method as claimed in claim 10, comprising the step of upon creation of said stored computer file also creating said archive copy of said computer file.

16. A method as claimed in claim 15, wherein said step of creating said archive copy operates to create said archive copy of said computer file for a subset of file types stored by said computer.

17. A method as claimed in claim 16, wherein said subset of file types include one or more of:
executable file types; and
dynamic link library file types.

18. A method as claimed in claim 10, wherein said alteration is a malicious alteration.

19. Apparatus for processing data operable to detect an alteration to a stored computer file, said apparatus comprising:
a file comparitor operable to compare said stored computer file with an archive copy of said computer file stored when said stored computer file was created; and
a comparison responder operable if said file comparing logic detects that said stored computer file and said archive computer file do not match to replace said stored computer file with said archive copy of said computer file.

20. Apparatus as claimed in claim 19, wherein said archive copy of said computer file is stored in one of:
an unencrypted form;
an encrypted form;
an encrypted media;
an encrypted volume; and
a PGP disk.

21. Apparatus as claimed in claim 19, wherein said archive copy of said computer file is stored in one of:
a different physical storage device to said stored computer file; and
a different part of a common physical storage device shared with stored computer file.

22. Apparatus as claimed in claim 19, wherein a subset of file types stored by said computer are subject comparison by said file comparitor and to creation of an archive copy for use with said file comparitor.

23. Apparatus as claimed in claim 22, wherein said subset of file types include one or more of:
executable file types; and
dynamic link library file types.

24. Apparatus as claimed in claim 19, comprising an archive file copier operable upon creation of said stored computer file to also created said archive copy of said computer file.

25. Apparatus as claimed in claim 24, wherein said archive file copier operates to create said archive copy of said computer file for a subset of file types stored by said computer.

26. Apparatus as claimed in claim 25, wherein said subset of file types include one or more of:
executable file types; and
dynamic link library file types.

27. Apparatus as claimed in claim 19, wherein said alteration is a malicious alteration.
